(19) United States
(12) Patent Application Publication
(10) Pub. No.: US 2020/0406346 A1
(43) Pub. Date: Dec. 31, 2020

(54) METAL NANO POWDER INCLUDING SOLID SOLUTION OF SILVER AND COPPER

(71) Applicant: YOUNG DONG TECH CO., LTD., Changwon-si, Gyeongsangnam-do (KR)

(72) Inventor: Chan Heon YOON, Changwon-si, Gyeongsangnam-do (KR)

(73) Assignee: YOUNG DONG TECH CO., LTD., Changwon-si, Gyeongsangnam-do (KR)

(21) Appl. No.: 16/615,620

(22) PCT Filed: Oct. 4, 2018
(86) PCT No.: PCT/KR2018/011724

§ 371 Date: Nov. 21, 2019

(30) Foreign Application Priority Data
Aug. 29, 2018 (KR) 10-2018-0101685

(51) Int. Cl. B22F 1/00; B22F 9/06; H01B 1/16

(52) U.S. Cl. CPC B22F 1/0018; B22F 9/06; B22F 2301/255; B22F 2304/054; B22F 2304/056; H01B 1/16

(57) ABSTRACT

Disclosed is nano powder formed of a solid solution including crystalline silver and amorphous copper. The metal nano powder has peaks in X-ray powder diffraction spectrum using a Cu-Kα radiation of 38.18±0.2, 44.6±0.2, 64.50±0.2, 77.48±0.2 and 81.58±0.2 at a diffraction angle of 2θ. A composition ratio of silver:copper of the metal nano powder is 5.0 to 8.0:2.0 to 5.0 at %.

### CROSS-REFERENCE TO PRIOR APPLICATIONS

This application is a National Stage patent application of PCT International Patent Application No. PCT/KR2018/011724 (filed on Oct. 4, 2018) under 35 U.S.C. § 371, which claims priority to Korean Patent Application No. 10-2018-0101685 (filed on Aug. 29, 2018), which are all hereby incorporated by reference in their entirety.

### BACKGROUND

The present invention relates to metal nano powder comprising a solid solution of silver and copper, and more particularly, to metal nano powder which exists in a form of metal nano powder formed of a solid solution consisting of crystalline silver with multi-face and uniform porosity and amorphous copper to significantly lower an oxidized rate as compared with a single metal even if being exposed in air and have excellent corrosion resistance and has excellent conductivity even in the form of powder, and as a result, has a remarkably low electric resistance compared to silver having the lowest electric resistance among metals.

With the development of high-tech industry-related technology, needs for fine materials having high functionality have been rapidly increased. Accordingly, in order to improve strength, hardness, wear resistance, corrosion resistance, heat resistance, etc., it is required to smoothly supply metal nano powder with highly controlled physical and chemical properties (particle size, shape, dispersion, purity, reactivity, conductivity, etc.).

In the material development, nano powders are mostly used as materials that require excellent physical properties and functionality, such as superconducting materials made much progress, amorphous alloys, mechanical alloying, and nano-composite materials. With the development of electronic industry, the demand for sub-micron or micron-sized metal powders used as raw materials for conductive inks, pastes and electrical material adhesives is increasing rapidly. In particular, attention has been focused on the improvement of properties such as a uniform soft magnetic property, a low eddy current loss, a relatively low core loss at a high frequency, and a thermal property. Therefore, a lot of researches have been performed for easily producing the metal nano powder.

However, in a principle, all materials may become a nano powder material, but due to thermodynamic stability, a difficulty in a manufacturing method, etc., the scope of practical application is not wide yet. The application width of the nano powder materials is rapidly increasing in the industrial field, but may be still weak compared to its potential.

For example, in the case of a metal material, if the size of the powder is continuously reduced, there is a problem of stability in which the powder becomes unstable due to an increase in surface energy depending on an increase in specific surface area (total surface area of the powder having a certain weight (1 g)). The nano powder has a problem in process technology that requires additional processing except for some technical areas that are utilized by itself.

In addition, since the metal nano powder is powdered and does not have conductivity, a usable area may be limited. In order to utilize industrially excellent characteristics of the nano powder, the nano powder needs to have economics at a level where the market mechanism is allowable. However, in many new developments, the price of nano powder is just above an acceptable level which may be easily on the market.

Therefore, in order to complement the above-mentioned problems, the present inventors recognized that it is urgent to develop the metal nano powder which has a multi-face and uniform porosity, may lower an oxidized rate even if being exposed in air to exhibit excellent corrosion resistance, has excellent conductivity, and has a significantly low electric resistance, and completed the present invention.

### PRIOR ARTS

### Patent Document

(Patent Document 1) Korean Patent Registration No. 10-1279640
(Patent Document 2) Korean Patent Registration No. 10-0428948

### Non-Patent Document

(Non-Patent Document 1) Electrochemistry Communications 9 (2007) 2514-2518
(Non-Patent Document 2) Metals 2014, 4(1), 65-83

### SUMMARY

An object of the present invention is to provide metal nano powder which is formed of a solid solution of crystalline silver with multi-face and uniform porosity and amorphous copper to significantly lower an oxidized rate as compared with a single metal even if being exposed in air and have excellent corrosion resistance.

Another object of the present invention is to provide metal nano powder which has more excellent conductivity than a single metal, and as a result, has a remarkably low electric resistance even compared to silver having the lowest electric resistance among metals.

In order to achieve the objects, the present invention provides metal nano powder having excellent conductivity.

Hereinafter, this specification will be described in more detail.

The present invention provides metal nano powder formed of a solid solution consisting of crystalline silver and amorphous copper.

In the present invention, the metal nano powder may be a silver-copper alloy.

In the present invention, the metal nano powder may have peaks in X-ray powder diffraction spectrum using a Cu-Kα radiation of 38.18±0.2, 44.6±0.2, 64.50±0.2, 77.48±0.2 and 81.58±0.2 at a diffraction angle of 2θ.

In the present invention, a composition ratio of silver:copper of the metal nano powder may be 5.0 to 8.0:2.0 to 5.0 at %.

In the present invention, the metal nano powder may have an electric resistance of 1.6Ω or less.

In the present invention, the metal nano powder may have peaks in X-ray powder diffraction spectrum using a Cu-Kα radiation of 29.8±0.2, 30.5±0.2, 32.3±0.2, 33.8±0.2, 35.0±0.2 and 36.2±0.2 at a diffraction angle of 2θ.

In the present invention, the metal nano powder may have an average diameter of 1 nm to 250 nm.

In the present invention, the metal nano powder may further comprise at least one selected from the group consisting of gold, zinc, tin, iron, aluminum, nickel or titanium.

The metal nano powder with excellent conductivity of the present invention is formed of the solid solution consisting of crystalline silver with multi-face and uniform property and amorphous copper to significantly lower an oxidized rate as compared with a single metal and have excellent corrosion resistance.

Further, the metal nano powder of the present invention has more excellent conductivity than the single metal, and as a result, has a significantly low electric resistance even compared to silver having the lowest electric resistance among metals to be applicable to various material fields such as semiconductors, OLEDs, etc.

### BRIEF DESCRIPTION OF THE DRAWINGS

FIG. 1 is a TEM image of checking particle sizes of metal nano powder of the present invention prepared according to Example 1.

FIG. 2 is a powder X-ray diffraction pattern of the metal nano powder of the present invention prepared according to Example 1.

FIG. 3 is powder X-ray diffraction patterns of (A) silver nano powder and (B) copper nano powder.

FIG. 4 is an image of confirming that the metal nano powder of the present invention prepared according to Example 1 is powder having conductivity.

FIG. 5 is a graph showing a linear polarization curve of pure magnesium (Mg) not coated in a 3.5% NaCl solution, aluminum (Al) foil, and the metal nano powder prepared in Example 1 which is coated with Al.

FIG. 6 is a diagram of confirming corrosion resistance on a pure Al foil specimen, a conventional silver-copper nano powder specimen, and the metal nano powder prepared in Example 1.

### DETAILED DESCRIPTION

The present invention provides metal nano powder with excellent conductivity.

Hereinafter, this specification will be described in more detail.

Metal Nano Powder

The present invention provides metal nano powder which is formed of a solid solution consisting of crystalline silver and amorphous copper.

The term “crystalline” used in the present invention means a property in which X-ray diffraction is confirmable by crystal lattices formed by a regular arrangement of atoms or molecules.

The term “amorphous” used in the present invention means a property in which there is no regularity as opposed to the crystalline in which atoms or molecules are regularly arranged.

The term “solid solution” used in the present invention means a general term for a solid mixture having a completely uniform phase, as a crystal in which some of atoms occupying the lattice position are statistically substituted with heteroatoms without changing a crystal structure on a crystal phase.

In the present invention, the metal nano powder may be a solid solution consisting of crystalline silver and amorphous copper.

In the present invention, since both the crystalline and the amorphous coexist, even if the metal nano powder is exposed in air, the oxidized rate may be significantly lowered as compared with a single metal or an alloy, and the metal nano powder exists in the form of powder, but may have conductivity. In particular, the metal nano powder of the present invention is hardly oxidized even at a strong acid such as hydrochloric acid, nitric acid, and sulfuric acid, and thus it may be confirmed that there is almost no change in color.

Further, the metal nano powder of the present invention consists of the crystalline silver and the amorphous copper to have significantly excellent conductivity as compared with a single metal such as silver or copper. As a result, the metal nano powder has an excellent effect of having a significantly low electric resistance even compared with silver having the lowest electric resistance among single metals and can be applied to various material fields such as semiconductors, OLEDs, etc.

In the present invention, the metal nano powder may have peaks in X-ray powder diffraction spectrum using a Cu-Kα radiation of 38.18±0.2, 44.6±0.2, 64.50±0.2, 77.48±0.2 and 81.58±0.2 at a diffraction angle of 2θ.

Preferably, the metal nano powder may have peaks in X-ray powder diffraction spectrum using a Cu-Kα radiation of 38.18±0.1, 44.6±0.1, 64.50±0.1, 77.48±0.1 and 81.58±0.1 at a diffraction angle of 2θ.

More preferably, the metal nano powder may have peaks in X-ray powder diffraction spectrum of FIG. 2.

In the present invention, a composition ratio of silver:copper of the metal nano powder may be 5.0 to 8.0:2.0 to 5.0 at %. Preferably, the composition ratio of silver:copper of the metal nano powder may be 5.0 to 7.0:3.0 to 5.0 at % and more preferably 5.5 to 6.5:3.5 to 4.5 at %.

The term “at %” used in the present invention refers to atom %, which forms the metal nano-powder.

In the present invention, the metal nano powder may have an electric resistance of 1.6Ω or less, specifically 1Ω or less, and more specifically 0.5Ω or less at room temperature.

In the present invention, the Ag (silver) as a metal of Group 11 and Period 5 on the Periodic Table representing electric conductivity of 6.30×10⁷ σ(S/m) at 20° C. is a metal which may have more excellent electric conductivity than that of gold having electric conductivity of 4.10×10⁷ σ(S/m) at 20° C. or copper having electric conductivity of 5.96×10⁷ σ(S/m). The metal nano powder of the present invention has a significantly low electric resistance compared to the silver to have an advantage that a current may flow well even if a lower voltage is used.

In the present invention, the metal nano powder may have an average diameter of 1 nm to 250 nm.

In the present invention, the metal nano powder may have a differential scanning calorimeter (DSC) endothermic transition at 179° C. to 181° C. when a heating rate is 10° C./min.

In the present invention, the DSC endothermic transition temperature is significantly reduced as compared with 961.78° C. and 1084.6° C. which are melting points of silver and copper constituting the metal nano powder, thereby reducing energy to be used in a process for lowering the melting point of the metal, and the metal nano powder is easily used in small-sized factories to be mass-produced in various fields.

However, the DSC endothermic transition value may vary according to the purity of the metal nano powder. For example, the DSC endothermic transition value may have a value within a range of 176° C. to 180° C. Further, this value may vary according to a heating rate of a device for measuring the DSC endothermic transition value.

In the present invention, the metal nano powder may further comprise at least one selected from the group consisting of gold, zinc, tin, iron, aluminum, nickel or titanium.

More specifically, the metal nano powder of the present invention may be 3-element metal nano powder containing three metals or 4-element metal nano powder containing four metals.

In the present invention, the metal nano powder is formed of crystalline silver with multi-face and uniform porosity and amorphous copper to lower the oxidized rate significantly as compared with a single metal even if being exposed in air and have electric conductivity despite of the powder form. As a result, the metal nano powder has a significantly low electric resistance even as compared to the silver having the lowest electric resistance among metals and thus can be applied to various material fields.

Further, the metal nano powder of the present invention has a significantly reduced melting point as compared to a melting point of a single metal to reduce energy to be used in the process for lowering the melting point of the metal and the metal nano powder is easily used in small-sized factories to be mass-produced in various fields.

In order to sufficiently appreciate the present invention, operational advantages of the present invention, objects achieved by exemplary embodiments the present invention, accompanying drawings illustrating the exemplary embodiments of the present invention and contents disclosed in the accompanying drawings should be referred.

Hereinafter, preferred exemplary embodiments of the present invention will be described in detail with reference to the accompanying drawings. However in description of the present invention, the description for known functions or configurations will be omitted in order to clarify the gist of the present invention.

Reagents and solvents to be mentioned hereinafter are purchased from Sigma Aldrich unless otherwise stated, and in reduced-pressure drying, unless otherwise stated, a reduced-pressure drier used OV-12 (manufacturer: Jeiotech in Korea) in the case of a vacuum oven and MD 4C NT (manufacturer: Vacuumbrand in Germany) in the case of a vacuum pump.

### Preparation Example 1 Metal Nano Powder of the Present Invention

Ammonia water was added to silver nitrate to form a transparent silver hydroxide colloid. Copper nano powder was added and mixed to the transparent silver hydroxide colloid to prepare metal nano powder. The prepared metal nano powder was washed with water three times and dried under reduced pressure to prepare metal nano powder formed of a solid solution consisting of crystalline silver and amorphous copper of the present invention.

### Experimental Example 1. Transmission Electron Microscope (TEM) Image—Confirmation of Particle Size

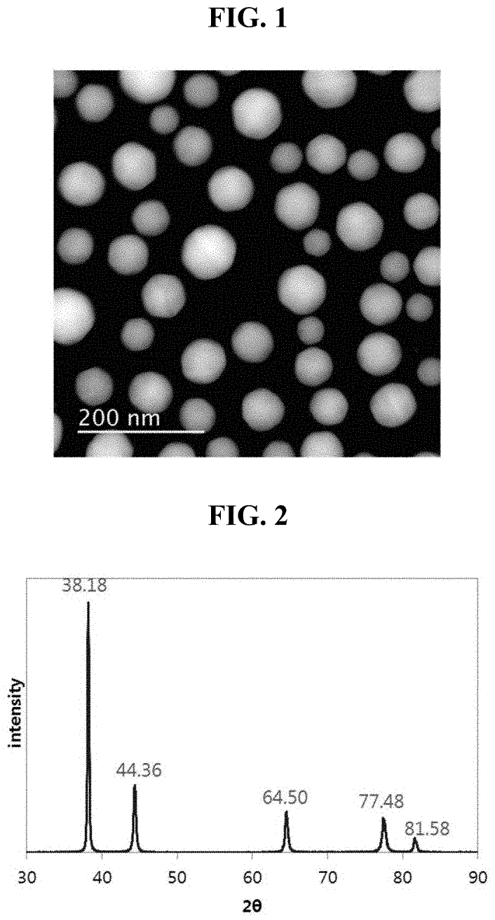

In order to confirm particle sizes of the metal nano powder of the present invention prepared in Example 1, the particle sizes were measured by using a transmission electron microscope (TEM) and the results thereof were illustrated in FIG. 1.

Referring to FIG. 1, it was confirmed that the metal nano powder of the present invention was formed to have a uniform diameter and had an average diameter of 1 nm to 250 nm.

### Experimental Example 2. Confirmation of Energy Dispersive x-Ray Spectroscopy (EDS) Composition

In order to confirm a composition of the metal nano powder of the present invention prepared in Example 1, the composition was measured by using an EDS and the results thereof were illustrated in Table 1 below.

TABLE 1

| | Composition ratio |
|---|---|
| Silver (Ag) | 61.92 |
| Copper (Cu) | 35.94 |
| Carbon (C) | 2.14 |

Referring to Table 1 above, it can be confirmed that the metal nano powder of the present invention consists of silver and copper and a composition ratio thereof is approximately silver:copper=6:4. However, in the case of carbon confirmed in the EDS, it is expected that a part of a film used to adsorb the metal nano powder is measured.

### Experimental Example 3. Confirmation of Powder x-Ray Diffraction Pattern

In order to confirm a powder x-ray diffraction pattern of the metal nano powder of the present invention prepared in Example 1, D8 Focus (Bruker (Germany)) was used, and specifically, measurement conditions were illustrated in Table 2 below.

TABLE 2

| | |
|---|---|
| Manufacturer | Bruker (Germany) |
| Model name | D8 Focus |
| Kβ remover | Ni filter |
| Voltage kV | 40 |
| Current, mA | 40 |
| scan range | 3 to 40 deg. |
| scan rate | 0.3 sec/step |
| increment | 0.02 deg. |
| Divergence slit width | 0.6 mm |
| Air scatter slit | 3 mm |
| Detector | LynxEye Detector (line detector) |

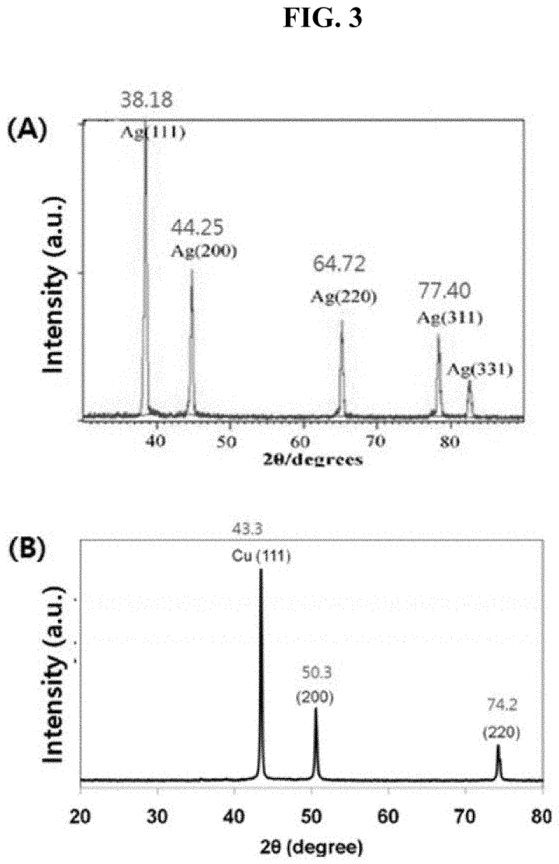

By the conditions, powder x-ray diffraction patterns of the metal nano powder of the present invention prepared in Example 1, silver nano powder, and copper nano powder were measured and the results thereof were illustrated in FIGS. 2 and 3.

Referring to FIG. 2, it can be confirmed that the metal nano powder of the present invention prepared in Example 1 has peaks in x-ray powder diffraction spectrum using a Cu-Kα radiation of 29.8±0.2, 30.5±0.2, 32.3±0.2, 33.8±0.2, 35.0±0.2 and 36.2±0.2 at a diffraction angle 2θ. In FIG. 3A, it can be confirmed that the peaks are almost the same as the silver nano powder and in FIG. 3B, it can be confirmed that there is no x-ray diffraction pattern of copper nano powder.

From the results, it can be confirmed that the metal nano powder of the present invention consists of silver and copper, but the silver becomes crystalline and the copper becomes amorphous.

### Experimental Example 4. Confirmation of Differential Scanning Calorimeter (DSC) Endothermic Transition

In order to endothermic transition of the metal nano powder of the present invention prepared in Example 1, a DSC 1 STARE system (Metter Toredo) was used and specifically, measurement conditions were illustrated in Table 3 below.

TABLE 3

| | |
|---|---|
| Manufacturer | Metter Toredo |
| Model name | DSC 1 STARE system |
| Heating rate | 10° C./min |

By the conditions, the endothermic transition of the metal nano powder of the present invention prepared in Example 1 was measured.

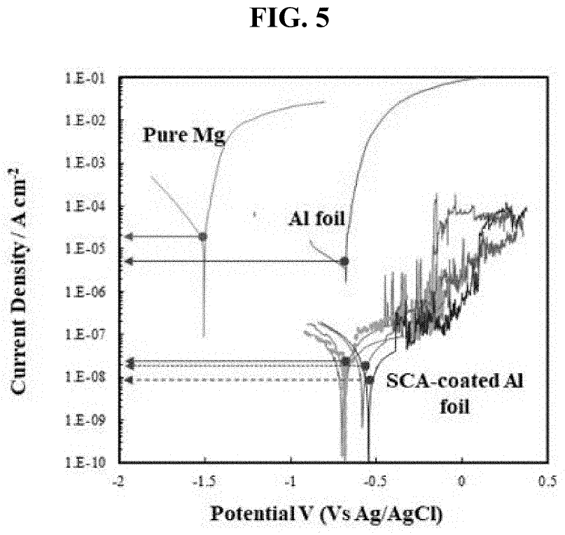

Referring to FIG. 5, it can be confirmed that the endothermic transition of the metal nano powder of the present invention prepared in Example 1 is about 180° C. In general, it can be confirmed that when it is considered that the endothermic transition of silver nano powder is about 961° C. and the endothermic transition of copper nano powder is about 1085° C., the endothermic transition of the metal nano powder of the present invention is significantly low.

From the results, the metal nano powder of the present invention may reduce energy to be used in a process of reducing a melting point of the metal and is easily used in small-sized factories to be mass-produced in various fields.

### Experimental Example 5. Confirmation of Conductivity

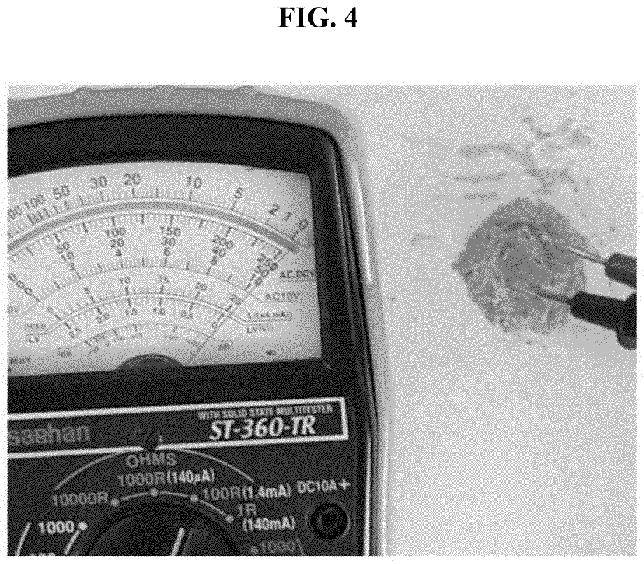

In order to confirm powder having conductivity of the metal nano powder of the present invention prepared in Example 1, a conductivity experiment was performed and the results thereof were illustrated in FIG. 4.

Referring to FIG. 4, it can be confirmed that the metal nano powder of the present invention is a material which is in a form of powder, but has conductivity. This is an effect shown when the metal nano powder of the present invention is formed of a solid solution consisting of crystalline silver and amorphous copper.

### Experimental Example 6. Confirmation of Metal Oxidation Rate

In order to confirm an oxidation rate of the metal nano powder of the present invention prepared in Example 1, (i) the metal nano powder prepared in Example 1, (ii) a single copper metal, and (iii) a single silver metal were exposed in air for 24 hours, 72 hours, 120 hours, and 400 hours and the oxidized degree under a 50% humidity condition was confirmed based on Table 4 below.

TABLE 4

| | |
|---|---|
| A | Non-oxidized state (0% to 10% of oxidized state) |
| B | Slight oxidation is performed and formation of a film starts |
| | (Oxidation state: 10% to 25%) |
| C | Oxidation is performed in half and the film is formed |
| | (Oxidation state: 25% to 60%) |
| D | Completely oxidized and the film is formed as a whole |
| | (Oxidation state: 60% to 100%) |

In the case of (ii) the single copper metal, when 24 hours elapsed, oxidation was already performed more than half to form a film, and at 72 hours, the oxidation was completely performed and then an oxide film was formed as a whole to become a D state. In the case of (iii) the single silver metal, when 24 hours elapsed, oxidation started to form a film and at 120 hours, the oxidation was completely performed and then an oxide film was formed as a whole to become a D state. However, (i) the metal nano powder prepared in Example 1 was in a state where the oxidation was almost not generated when 400 hours elapsed. Since the crystalline silver and the amorphous copper coexist, the metal nano powder of the present invention may significantly lower an oxidized rate as compared to a general single metal.

### Experimental Example 7. Confirmation of Electric Conductivity and Electric Resistance

In order to confirm electric conductivity and an electric resistance of the metal nano powder of the present invention prepared in Example 1, electric resistances before and after heat treatment of the metal nano powder were measured using a 4-point probe and the results thereof were illustrated in Table 4 below.

TABLE 5

| Heat-treatment | | |
|---|---|---|
| temperature/ | Before heat | After heat |
| Retention time | treatment | treatment |
| Room temperature | 1.428 Ω/sq | — |
| 120° C./5 min | | 0.416 Ω/sq |
| 150° C./5 min | | 0.325 Ω/sq |
| 180° C./5 min | | 0.260 Ω/sq |
| 400° C./5 min | | 0.210 Ω/sq |

Referring to Table 5 above, an electric resistance value before the heat treatment of the metal nano powder prepared in Example 1 is 1.428 Ω/sq, which is very similar to 1.590 Ω/sq as a resistance value of silver (Ag) at room temperature. However, it can be confirmed that when the metal nano powder prepared in Example 1 is heat-treated at 120° C., 150° C., 180° C., and 400° C., the electric resistance value is reduced up to a maximum of 0.210 Ω/sq. From the results, it can be confirmed that the metal nano powder of the present invention has a significantly low electric resistance value even as compared to silver known that a resistance value is lowest as a single metal and thus has excellent electric conductivity.

### Experimental Example 8. Confirmation of Corrosion Resistance

1. Confirmation of Corrosion Resistance Through Electrochemical Experiment

A corrosion inhibition property of nanopaint coatings in a saline was measured by an electrochemical experiment (measurement of potential mechanical polarization) using an Autolab PGSTAT constant current/constant potential system [Chang C H, et al., Carbon 2012; 50: 5044-51]. The measurement was performed in a 3.5% NaCl electrolyte solution at room temperature. In a conventional three-electrode system battery, a platinum counter electrode, a silver/silver chloride (Ag/AgCl) reference electrode, and a test sample (exposed area of 1 cm²) as a working electrode were used together. Before the polarization measurement, an open circuit potential (OCP) was monitored for 1 hour to confirm the stability. Once the stable OCP was determined, the upper and lower potential limits of a linear sweep voltammetry for the OCP were set to +200 mV and −200 mV, respectively. A sweep rate was 1 mV·s⁻¹. A corrosion potential Ecorr and a corrosion current Icon were determined by Tafel extrapolation.

Tafel electrochemical analysis is one of standard methods used for the study of corrosion in the metal. Corrosion behavior of the metal may be described by combining anodic oxidation of the metal to metal ions and cathodic reduction utilizing electrons that disappear during the oxidation reaction. Both reactions occur at the same time, and thus the limitation of these reactions causes the inhibition of corrosion.

The potential mechanical polarization curve measured in a 3.5% NaCl solution was illustrated in FIG. 5 with respect to non-coated pure Mg (magnesium), aluminum foil, and the metal nano powder prepared in Example coated with aluminum. With respect to the non-coated pure Mg (magnesium), the aluminum foil, and the metal nano powder prepared in Example coated with aluminum, a corrosion potential Ecorr and a corrosion current density Icorr were added to the Tafel formula to be calculated from the polarization curve.

Referring to FIG. 5, it can be confirmed that an anodic current density of the metal nano powder prepared in Example coated with aluminum has a lower current density than the non-coated pure Mg (magnesium) and the aluminum foil. It can be seen that the dissolution of metal ions from the metal nano powder prepared by Example 1 coated with aluminum is significantly reduced.

2. Confirmation of Corrosion Resistance Through Salt Spray Test

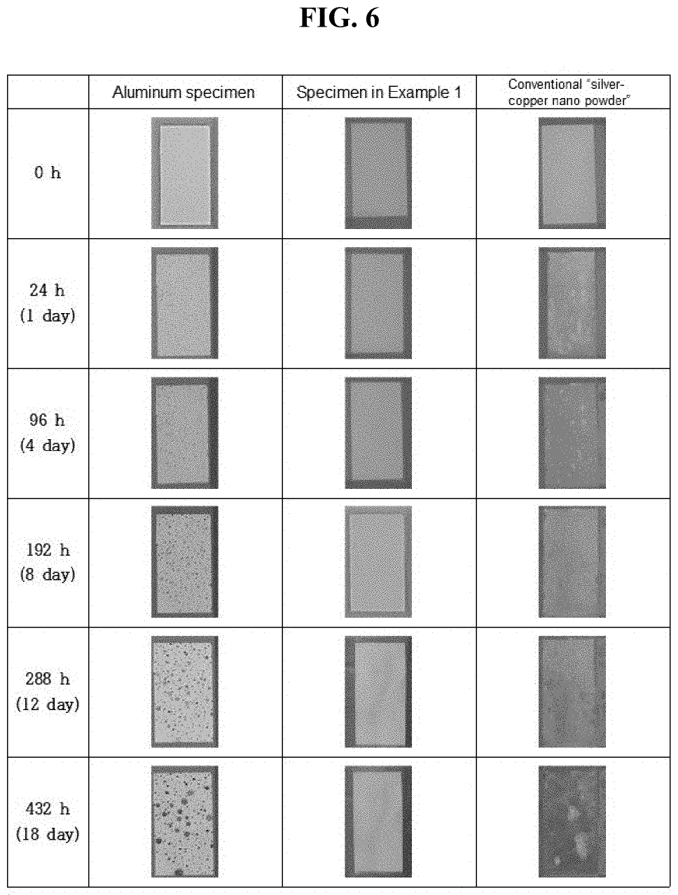

In order to confirm corrosion resistance for a pure aluminum foil specimen, a conventional silver-copper nano powder specimen, and the metal nano powder prepared by Example 1, the confirmation of the corrosion resistance was performed based on a salt spray test method specified in JIS-Z-2371. 5 wt % of a saline solution was sprayed in a tester, the temperature was maintained at 35° C., and a change in color of the specimen from 0 to 432 hours (0, 24, 96, 192, 288 and 432 hours) was confirmed, and then the results were illustrated in FIG. 6.

Referring to FIG. 6, in the case of the aluminum foil specimen, it can be confirmed that from 24 hours, the corrosion occurs while the aluminum foil is peeled. Even in the case of the conventional silver-copper nano powder, it can be confirmed that when 24 hours elapses, the corrosion rapidly occurs, and when 288 hours (12 days) elapses, the corrosion occurs on the entire specimen. On the other hand, in the metal nano powder of the present invention prepared by Example 1, it can be confirmed that even though 432 hours (18 days) elapsed, the corrosion does almost not occur and no peeling on the specimen occurs. From the results, it can be confirmed that the metal nano powder of the present invention exhibits excellent corrosion resistance.

The present invention is not limited to the exemplary embodiments described herein, and it would be apparent to those skilled in the art that various changes and modifications might be made without departing from the spirit and the scope of the present invention. Therefore, it will be determined that the changed examples or modified examples are included in the appended claims of the present invention.

1. Metal nano powder formed of a solid solution comprising crystalline silver and amorphous copper,
wherein ammonia water is added to silver nitrate to form a transparent silver hydroxide colloid,
wherein the transparent silver hydroxide is formed into crystalline silver and amorphous solid solution by adding the same nano powder to the colloid,
wherein X-ray powder diffraction spectral peaks using Cu-Kα radiation exhibit peaks at 38.18, 44.6, 64.50, 77.48 and 81.58 at diffraction angle 2θ,
wherein the composition ratio of silver:copper is 6.0-7.0:3.0-4.0 at %, and
wherein the metal nano powder has an endothermic transition temperature of 179° C. to 181° C. when the Differential Scanning calorimeter (DSC) is measured at a heating rate of 10° C./min using the DSC 1 STARE system.

2. (canceled)

3. (canceled)

4. The metal nano powder of claim 1, wherein the metal nano powder has an electric resistance of 1.6Ω or less.

5. The metal nano powder of claim 1, wherein the metal nano powder has an average diameter of 1 nm to 250 nm.

6. The metal nano powder of claim 1, further comprising:
at least one selected from the group consisting of gold, zinc, tin, iron, aluminum, nickel or titanium.
